(19) United States
(12) Patent Application Publication
(10) Pub. No.: US 2026/0205236 A1
(43) Pub. Date: Jul. 16, 2026

(54) PHASE MASKING IN COHERENT FEDERATED MACHINE LEARNING

(71) Applicant: QUALCOMM Incorporated, San Diego, CA (US)

(72) Inventors: Yuval Ben Hur, Nesher (IL); Evgeny Levitan, Haifa (IL); Ariel Yaakov Sagi, Haifa (IL); Reuven Alpert, Givat Ada (IL); Amit Moses, Tel Aviv (IL); Ronen Shaked, Kfar Saba (IL); Gideon Shlomo Kutz, Ramat Hasharon (IL)

(21) Appl. No.: 19/023,596

(22) Filed: Jan. 16, 2025

(51) Int. Cl. H04L 5/00; H04L 41/16

(52) U.S. Cl. CPC H04L 5/0007; H04L 41/16

(57) ABSTRACT

A device for federated machine learning, comprising: a communication system; one or more memories configured to store: values of model parameters of a machine learning (ML) model, and phase values; and one or more processors are configured to: apply the ML model, using the values of the model parameters, to model input data to determine model output data; determine an error function based on the model output data and expected output data; calculate a gradient of the error function; generate a plurality of frequency-domain values based on the gradient; generate modified frequency-domain values based on the phase values and the frequency-domain values; generate a time-domain digital signal based on the modified frequency-domain values; wherein the communication system is configured to transmit an analog radio frequency (RF) signal based on the time-domain digital signal.

### TECHNICAL FIELD

The technology discussed below relates generally to wireless communication systems.

### BACKGROUND

Network nodes in a wireless communication system may use machine learning (ML) models for various purposes. For example, network nodes may use ML models for location mapping, route planning, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security and so on. The network nodes may use a federated machine learning system to share updates to the ML models without disclosing model input data or model output data to other network nodes.

### SUMMARY

The following presents a summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. Unless expressly described, no one aspect or feature is essential to achieve technical effects or solutions discussed herein.

As described herein, a client device of a federated machine learning system applies an ML model, using values of the model parameters, to model input data to determine model output data. The client device determines an error function based on the model output data and expected output data. The client device calculates a gradient of the error function and generates a plurality of frequency-domain values based on the gradient. Conventionally, in a federated ML system, the client device transmits a time-domain RF signal generated based on the frequency-domain values. Because partial derivatives of the gradient for different model parameters are likely to be correlated, the frequency-domain values are also likely correlated. As a result, a time-domain signal generated based on the frequency-domain values may include abrupt peaks. These peaks may cause undesirable surges of power requirements.

The techniques of this disclosure may address this problem. According to the techniques of this disclosure, the client device may determine modified frequency-domain values by applying phase values to the frequency-domain values. In other words, the client device may apply a phase mask to the frequency-domain values. The phase values may be preselected on a pseudorandom basis. Modifying the frequency-domain values based on the phase values may reduce correlation among the frequency-domain values, which may therefore decrease the likelihood of abrupt peaks in the time-domain RF signal.

In one example, this disclosure describes a device for federated machine learning, comprising: a communication system; one or more memories configured to store: values of model parameters of a machine learning (ML) model, and phase values; and one or more processors are configured to: apply the ML model, using the values of the model parameters, to model input data to determine model output data; determine an error function based on the model output data and expected output data; calculate a gradient of the error function; generate a plurality of frequency-domain values based on the gradient; generate modified frequency-domain values based on the phase values and the frequency-domain values; and generate a time-domain digital signal based on the modified frequency-domain values; and wherein the communication system is configured to transmit an analog radio frequency (RF) signal based on the time-domain digital signal.

In another example, this disclosure describes a device for federated machine learning, comprising: a communication system configured to receive an analog RF signal; one or more memories configured to store: values of model parameters of a machine learning (ML) model, and phase values; and one or more processors are configured to: generate a digital time-domain signal based on the analog RF signal; determine modified frequency-domain values based on the digital time-domain signal; reconstruct frequency-domain values based on the phase values and the modified frequency-domain values; determine a gradient of an error function based on the reconstructed frequency-domain values; and apply a backpropagation process that determines updated values of the model parameters based on the gradient of the error function.

In another example, this disclosure describes a method for federated machine learning, the method comprising: storing, by a client device of a federated machine learning system, values of model parameters of a machine learning (ML) model; storing, by the client device, phase values; applying, by the client device, the ML model, using the values of the model parameters, to model input data to determine model output data; determining, by the client device, an error function based on the model output data and expected output data; calculating, by the client device, a gradient of the error function; generating, by the client device, a plurality of frequency-domain values based on the gradient; generating, by the client device, modified frequency-domain values based on the phase values and the frequency-domain values; generating, by the client device, a time-domain digital signal based on the modified frequency-domain values; and transmitting, by the client device, an analog radio frequency (RF) signal based on the time-domain digital signal.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3A is a schematic illustration of a user plane protocol stack and a control plane protocol stack in accordance with some aspects of this disclosure.

FIG. 3B is a schematic illustration of a user plane protocol stack and a control plane protocol stack for a sidelink interface between a pair of UEs in accordance with some aspects of this disclosure.

FIG. 4 schematically illustrates various aspects of the present disclosure with reference to an Orthogonal Frequency Division Multiplexing (OFDM) waveform.

FIG. 5 is a conceptual diagram illustrating an example system that performs federated machine learning, in accordance with one or more techniques of this disclosure.

FIG. 6 is a block diagram illustrating an example of a hardware implementation for a network node, in accordance with one or more techniques of this disclosure.

FIG. 7 is a flowchart illustrating an example process performed by client devices, in accordance with one or more techniques of this disclosure.

FIG. 8 is a flowchart illustrating an example operation of a central device, in accordance with one or more techniques of this disclosure.

FIG. 9 is a conceptual diagram illustrating an example effect of correlation of frequency-domain values when transformed into a time-domain signal.

FIG. 10 is a graph showing an example effect of applying the phase values to the frequency-domain values, in accordance with one or more techniques of this disclosure.

FIG. 11 is a graph showing an example effect of apply the phase values to the frequency-domain values, in accordance with one or more techniques of this disclosure.

FIG. 12 is an illustrative block diagram of an example machine learning (ML) model represented by an artificial neural network (ANN).

### DETAILED DESCRIPTION

Machine learning (ML) models are becoming increasingly ubiquitous in modern electronic devices. For example, wireless devices may use ML models for spectrum management, power management, position determination, and so on. In some instances, devices may use federated machine learning to update their ML models.

Federated machine learning is a technique in which multiple client entities (e.g., User Equipment (UE) devices) collaborate to train a ML model. Individual client entities may generate model input data, apply a ML model to the model input data to generate model output data, apply an error function to the model output data and expected model output data, determine a gradient of the error function, and apply a training process that updates values of model parameters based on the gradient of the error function. In a federated machine learning system, the client entities may share the gradient or updated values of the model parameters with a central entity without sharing the model input data with the central entity. The central entity may determine updated values of the model parameters based on the information shared by multiple entities. The central entity may then provide the updated values of the model parameters back to the client entities. Because the central entity does not receive the model input data, privacy and security of the model input data may be maintained. For instance, in the example where ML models are used to predict travel times between destinations, the client devices may generate model input data indicating that a particular user wants to travel from location A to location B and the client device may monitor how long it actually takes the particular user to travel from location A to location B. The client entity may use this information to train a local instance of the ML model. The client entity may share information, such as gradients or updated values of model parameters, with a central entity without sharing that the particular user wanted to travel from location A to location B or how long it actually took for the particular user to travel from location A to location B. The client entities may receive updates from the central entity, thus improving the instances of the ML models at the client entities, thereby improving the client entities' ability to predict travel times between durations, even for pairs of destinations that the particular user has not yet requested.

Federated machine learning can be implemented at a physical layer of a wireless network specification. For example, client entities may determine a gradient of an error function as described above, map partial derivatives of the error function with respect to different model parameters to resource elements (REs) of a resource block, modulate the REs as Orthogonal Frequency Division Multiplexing (OFDM) symbols, and transmit an analog RF signal representing the OFDM symbols. The client entities may synchronize transmission of the analog RF signals such that an analog RF signal received by a central entity is a summation of the analog RF signals transmitted by the client entities. The central entity may use the received analog RF signal to reconstruct the gradient of the error function and update values of the model parameters accordingly. The central entity may transmit an analog signal back to the client entities representing the updated values of the model parameters. The client entities may then use the updated values of the model parameters in their local instances of the ML model.

Gradients are often highly correlated across model parameters. That is, a gradient may comprise a vector of elements that indicate partial derivatives of the error function with respect to different model parameters. The partial derivatives of the error function with respect to adjacent model parameters are likely to be similar to one another. When mapping the partial derivatives to REs, the client entity may generate frequency-domain values, each of which based on one or more partial derivatives of the gradient with respect to one or more of the model parameters. The client device may then apply an Inverse Fast Fourier transform (IFFT) to the frequency-domain values to generate a time-domain digital signal. Due to the application of the IFFT and due to the correlation between partial derivatives, the time-domain digital signal is likely to include sudden peaks when there are no substantial differences between partial derivatives (and hence frequency-domain values) while being relatively steady for most partial derivatives.

These peaks may draw sudden surges of electrical current, resulting in reduced power efficiency. Sudden draws of electrical current may be problematic because the peaks may require a power amplifier to operate at a large backoff, thereby reducing the power efficiency of the power amplifier.

This disclosure describes techniques that may address these issues. As described herein, a client device may comprise a communication system. The client device may store values of model parameters of a machine learning (ML) model. In addition, the client device may store phase values. The client device may apply the ML model, using the values of the model parameters, to model input data to determine model output data. The client device may then apply an error function to the model output data and expected output data. The client device may calculate a gradient of the error function. The client device may generate frequency-domain values based on gradient for the model parameters. The client device may then generate modified frequency-domain values based on the phase values and the frequency-domain values. The client device may generate a time-domain digital signal based on the modified frequency-domain values and transmit and an analog RF signal based on the digital time-domain signal.

A central device may store values of model parameters of the ML model and the phase values. The phase values may be the same as the phase values stored by the client devices. The central device may generate receive an analog RF signal. The analog RF signal may be an aggregate of analog RF signals transmitted concurrently by two or more client devices. The central device may generate a digital time-domain signal based on the analog RF signal. The central device may then determine aggregated modified frequency-domain values based on the digital time-domain signal. The central device may reconstruct frequency-domain values based on the phase values and the modified frequency-domain values. The central device may determine a gradient based on the reconstructed frequency-domain values. Furthermore, the central device may apply a backpropagation process that updates the values of the model parameters based on the gradient of the error function. In some examples, the central device may generate model update data and transmit the model update data to the client devices. The model update data may include the gradient, the updated values of the model parameters, or other information to enable the client devices to update their values of the model parameters.

Application of the phase values to the frequency-domain values may reduce occurrence of the peaks in power output because the modified frequency-domain values are less correlated. In this way, the techniques of this disclosure may reduce amount of power draw on batteries or enhance the power efficiency of client devices.

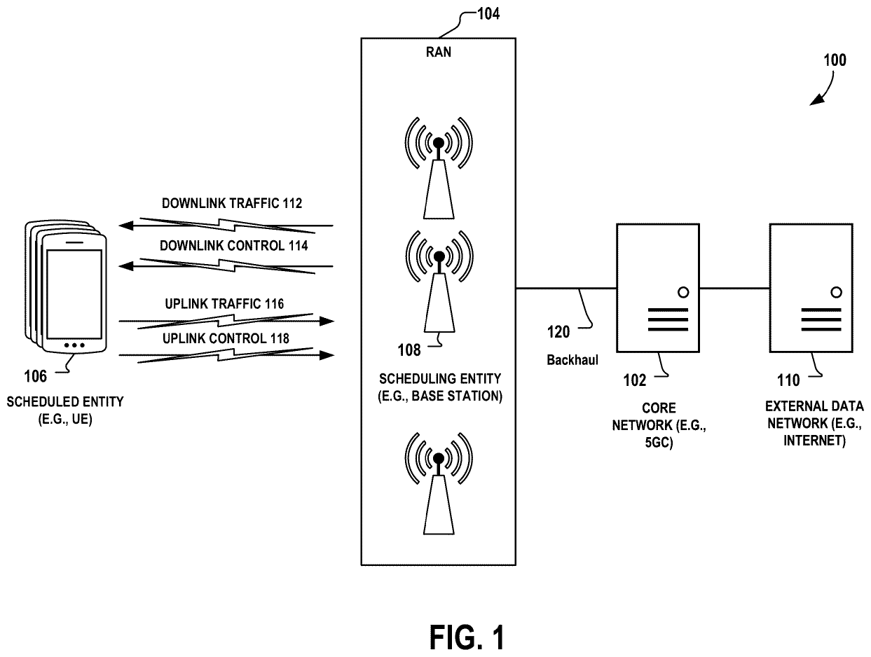

The disclosure that follows presents various concepts that may be implemented across a broad variety of telecommunication systems, network architectures, and communication standards. FIG. 1 is a schematic illustration of a wireless communication system according to some aspects of this disclosure. Referring now to FIG. 1, as an illustrative example without limitation, this schematic illustration shows various aspects of the present disclosure with reference to a wireless communication system 100. Wireless communication system 100 includes several interacting domains: a core network 102, a radio access network (RAN) 104, and a scheduled entity. The scheduled entity may be any type of device on a schedule of devices configured for transmitting and receiving data in wireless communication system 100. User equipment (UE) is a common form of scheduled entity. Accordingly, for ease of explanation, this disclosure refers to the scheduled entity as UE. FIG. 1 shows scheduled entity 106 as user equipment (UE). By virtue of wireless communication system 100, the UE may be enabled to carry out data communication with an external data network 110, such as (but not limited to) the Internet.

RAN 104 may implement any suitable wireless communication technology or technologies to provide radio access to scheduled entity 106. As one example, RAN 104 may operate according to 3rd Generation Partnership Project (3GPP) New Radio (NR) specifications, often referred to as 5G or 5G NR, or the emerging 6G specification. In some examples, RAN 104 may operate under a hybrid of multiple specifications, such as 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, RAN 104 includes a plurality of scheduling entities 108, such as base stations. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (also known as a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), a vehicle, and a broad array of embedded systems, e.g., corresponding to an “Internet of things” (IoT). A mobile apparatus, such as a UE, may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between RAN 104 and scheduled entity 106 may be described as utilizing an air interface. Transmissions over the air interface from a base station (e.g., one of scheduling entities 108) to one or more UEs (e.g., scheduled entity 106) may be referred to as downlink (DL) transmission. In accordance with certain aspects of the present disclosure, the term downlink may refer to a point-to-multipoint transmission originating at one of scheduling entities 108 (e.g., a base station). Another way to describe this scheme may be to use the term broadcast channel multiplexing. Transmissions from a UE (e.g., scheduled entity 106) to a base station (e.g., one of scheduling entities 108) may be referred to as uplink (UL) transmissions. In accordance with further aspects of the present disclosure, the term uplink may refer to a point-to-point transmission originating at scheduled entity 106 (e.g., a UE).

In some examples, access to the air interface may be scheduled, wherein one or more of scheduling entities 108 (e.g., a network node) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by the scheduling entity.

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a network node (e.g., one or more of scheduling entities 108) may broadcast downlink traffic 112 to one or more UEs 106. Broadly, the network node is a node or device responsible for scheduling traffic in a wireless communication network, including downlink traffic 112 and, in some examples, uplink traffic 116 from one or more scheduled entities (e.g., scheduled entity 106) to the network node. On the other hand, scheduled entity 106 (e.g., a UE) is a node or device that receives downlink control information 114, including but not limited to scheduling information (e.g., a grant), synchronization or timing information, or other control information from another entity in the wireless communication network such as the network node.

Network nodes (such as scheduling entities 108) may include a backhaul interface for communication with a backhaul portion 120 of the wireless communication system. Backhaul portion 120 may provide a link between a network node and core network 102. Further, in some examples, a backhaul network may provide interconnection between the respective network nodes. Various types of backhaul interfaces may be employed, such as a direct physical connection, a virtual network, or the like using any suitable transport network.

Core network 102 may be a part of wireless communication system 100, and may be independent of the radio access technology used in RAN 104. In some examples, core network 102 may be configured according to 5G standards (e.g., 5GC). In other examples, the core network 102 may be configured according to a 4G evolved packet core (EPC), or any other suitable standard or configuration.

In the example of FIG. 1, scheduled entities 106, scheduling entities 108, and/or other devices in wireless communication system 100 may perform federated machine learning. For example, each of scheduled entities 106 may be a client device of a federated ML system and may host an instance of a ML model. One or more of scheduling entities 108 may be a central device of the federated ML system. Each of scheduled entities 106 store values of model parameters of an ML model. The scheduled entity may apply the ML model, using the values of the model parameters, to model input data to generate model output data. The scheduled entity may apply an error function to the model output data and expected output data. The scheduled entity may calculate a gradient of the error function. The scheduled entity may generate a plurality of frequency-domain values based on the gradient. The scheduled entity may generate modified frequency-domain values based on the phase values and the frequency-domain values. The scheduled entity may generate a time-domain digital signal based on the frequency-domain values. A communication system of the scheduled entity may be configured to transmit an analog RF signal based on the time-domain digital signal.

In some examples, a scheduling entity (e.g., one of scheduling entities 108) may act as a central entity of the federated ML system. In accordance with one or more techniques of this disclosure, the scheduling entity may store values of model parameters of a machine learning (ML) model and store the phase values. The scheduling entity may receive an analog RF signal and generate a digital time-domain signal based on the analog RF signal. The scheduling entity may determine modified frequency-domain values based on the digital time-domain signal. Additionally, the scheduling entity may reconstruct frequency-domain values based on the modified frequency-domain values and the phase values. The scheduling entity may determine a gradient of the error function based on the reconstructed frequency-domain values. Additionally, the scheduling entity may apply a backpropagation process that updates the values of the model parameters based on the gradient of the error function.

As previously discussed, the partial derivatives expressed in the gradient are often highly correlated. Therefore, the frequency-domain values may also be highly correlated. This may lead to sudden changes in power demand, which may shorten battery life or cause device crashes. Application of the phase values may avoid this problem by reducing correlation between the frequency-domain values.

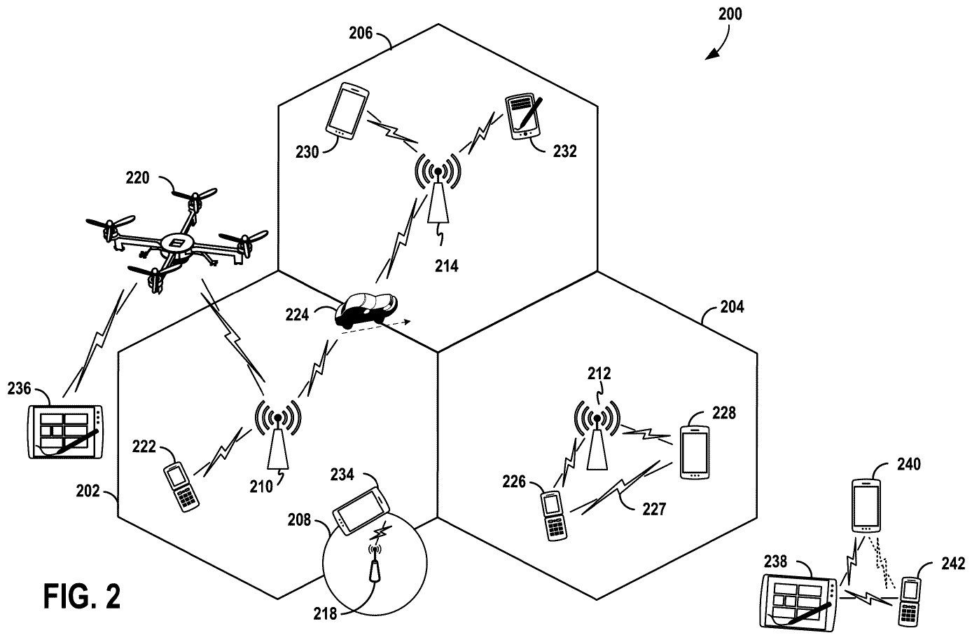

FIG. 2 provides a schematic illustration of a RAN 200, by way of example and without limitation. In some examples, RAN 200 may be the same as RAN 104 described above and illustrated in FIG. 1. The geographic area covered by RAN 200 may be divided into cellular regions (cells) that a UE can uniquely identify based on an identification broadcasted from one access point, base station, or network node. FIG. 2 illustrates macrocells 202, 204, and 206, and a small cell 208.

FIG. 2 shows two three network nodes 210, and 212, and 214 in cells 202, 204, and 206. In the illustrated example, cells 202, 204, and 206 may be referred to as macrocells, because network nodes 210, 212, and 214 support cells having a large size. Further, a network node 218 is shown in small cell 208 (e.g., a microcell, picocell, femtocell, home base station, home Node B, home eNode B, etc.) which may overlap with one or more macrocells. In this example, small cell 208 may be referred to as a small cell, because network node 218 supports a cell having a relatively small size. Cell sizing can be done according to system design as well as component constraints.

RAN 200 may include any quantity of wireless network nodes and cells. Further, RAN 200 may include a relay node to extend the size or coverage area of a given cell. Network nodes 210, 212, 214, 218 provide wireless access points to a core network for any quantity of mobile apparatuses. In some examples, network nodes 210, 212, 214, and/or 218 may be the same as scheduling entities 108 described above and illustrated in FIG. 1.

FIG. 2 further includes an unmanned aerial vehicle (UAV) 220, such as a quadcopter or drone, which may be configured to function as a network node. That is, in some examples, a cell may not necessarily be stationary, and the geographic area of the cell may move according to the location of a mobile network node such as UAV 220.

Within RAN 200, each of network nodes 210, 212, 214, 218, and UAV 220 may be configured to provide an access point to a core network 102 (see FIG. 1) for all the UEs in the respective cells. For example, UEs 222 and 224 may be in communication with network node 210; UEs 226 and 228 may be in communication with network node 212; UEs 230 and 232 may be in communication with network node 214; UE 234 may be in communication with network node 218; and UE 236 may be in communication with a mobile network node, such as UAV 220. In some examples, UEs 222, 224, 226, 228, 230, 232, 234, 236, 238, 240, and/or 242 may be the same as the UE/scheduled entity 106 described above and illustrated in FIG. 1.

In some examples, a mobile network node (e.g., UAV 220) may be configured to function as a UE. For example, UAV 220 may operate within cell 202 by communicating with network node 210.

In a further aspect of RAN 200, sidelink signals may be used between UEs without necessarily relying on scheduling or control information from a network node (e.g., a scheduling entity). For example, two or more UEs (e.g., UEs 226 and 228) may communicate with each other using peer to peer (P2P) or sidelink signals 227 without relaying that communication through a network node. In a further example, UE 238 is illustrated communicating with UEs 240 and 242. Here, UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with a scheduling entity, such as UE 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In order for transmissions over the radio access network 200 to obtain a low block error rate (BLER) while still achieving very high data rates, a transmitter may use channel coding. That is, wireless communication may generally utilize a suitable error correcting block code. In a typical block code, a transmitter splits up an information message or sequence into code blocks (CBs), and an encoder (e.g., a CODEC) at the transmitting device then mathematically adds redundancy to the information message. Exploitation of this redundancy in the encoded information message can improve the reliability of the message, enabling correction for bit errors that may occur due to the noise.

In 5G NR specifications (Release 15), data is coded in differing manners. User data (e.g., data, data traffic, traffic, etc.) may be coded using quasi-cyclic low-density parity check (LDPC) with two different base graphs. One base graph is used for large code blocks and/or high code rates, while another base graph is used otherwise. Control information and the physical broadcast channel (PBCH) may be coded using Polar coding (e.g., based on nested sequences). For the control information and the PBCH, puncturing, shortening, and repetition are used for rate matching.

Those of ordinary skill in the art will understand that aspects of the present disclosure may be implemented utilizing any suitable channel code. Various implementations of scheduling entities 108 and scheduled entities 106 may include suitable hardware and capabilities (e.g., an encoder, a decoder, and/or a CODEC) to utilize one or more of these channel codes for wireless communication.

The air interface in the radio access network 200 may utilize one or more multiplexing and multiple access algorithms to enable simultaneous communication of the various devices. For example, 5G NR specifications provide multiple access for UL transmissions from UEs 222 and 224 to network node 210, and for multiplexing for DL transmissions from network node 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a network node may multiplex DL transmissions to UEs utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

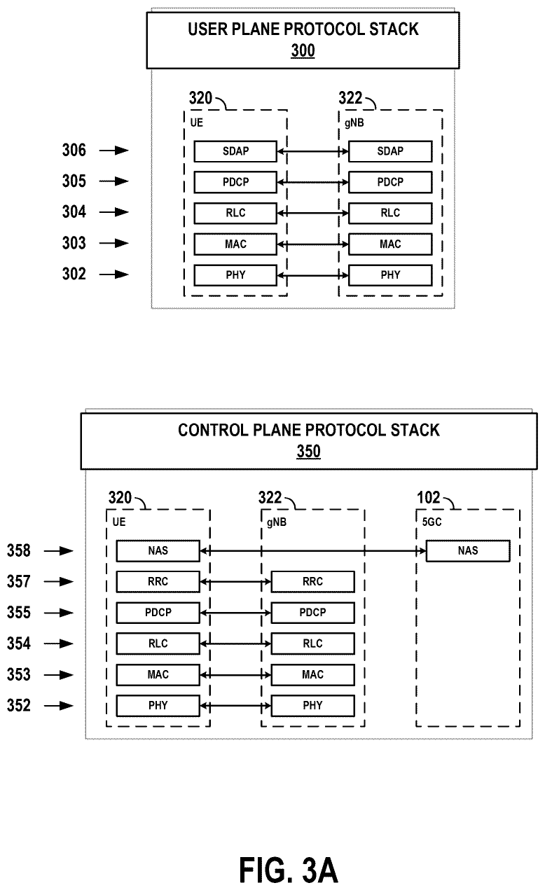

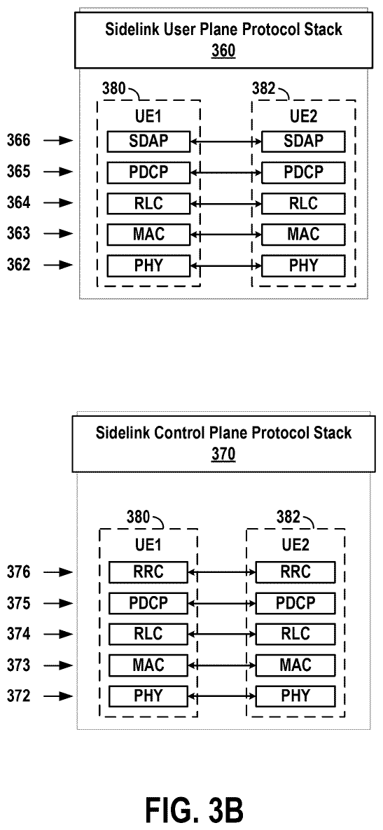

FIG. 3A is a schematic illustration of a user plane protocol stack 300 and a control plane protocol stack 350 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS 358) and Access Stratum (AS 302-306 and 352-357) layers and protocols. A NAS protocol 358 provides upper layers, for signaling between scheduled entity 106 and core network 102 (referring to FIG. 1). The AS protocol 302-306 and 352-357 provides lower layers, for signaling between RAN 104 (e.g., a gNB, network node, or scheduling entities 108) and scheduled entity 106.

Radio bearers between a network node (e.g., one of scheduling entities 108) and scheduled entity 106 may be categorized as data radio bearers (DRB) for carrying user plane data, corresponding to user plane protocol stack 30; and signaling radio bearers (SRB) for carrying control plane data, corresponding to control plane protocol stack 350.

In the AS, protocols of both user plane protocol stack 300 and control plane protocol stack 350 include a physical layer (PHY) 302/352, a medium access control layer (MAC) 303/353, a radio link control layer (RLC) 304/354, and a packet data convergence protocol layer (PDCP) 305/355. PHY 302/352 is the lowest layer and implements various physical layer signal processing functions. MAC layer 303/353 provides multiplexing between logical and transport channels and is responsible for various functions. For example, the MAC layer 303/353 is responsible for reporting scheduling information, priority handling and prioritization, and error correction through hybrid automatic repeat request (HARQ) operations. RLC layer 304/354 provides functions such as sequence numbering, segmentation and reassembly of upper layer data packets, and duplicate packet detection. PDCP layer 305/355 provides functions including header compression for upper layer data packets to reduce radio transmission overhead, security by ciphering the data packets, and integrity protection and verification.

In user plane protocol stack 300, a service data adaptation protocol (SDAP) layer 306 provides services and functions for maintaining a desired quality of service (QoS). In control plane protocol stack 350, a radio resource control (RRC) layer 357 includes a quantity of functional entities for routing higher layer messages, handling broadcasting and paging functions, establishing and configuring radio bearers, NAS message transfer between NAS and UE, etc.

NAS protocol 358 provides for a wide variety of control functions between scheduled entity 106 and core network 102. These functions include, for example, registration management functionality, connection management functionality, and user plane connection activation and deactivation.

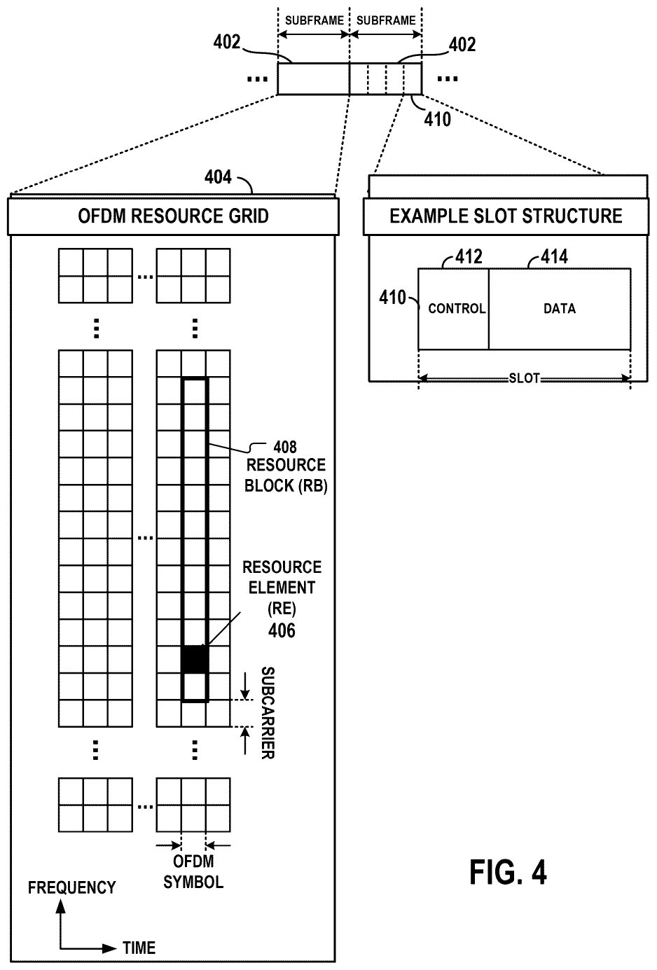

FIG. 4 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. Further, each frame may include a set of subframes (e.g., 10 subframes of 1 ms each). A given carrier may include one set of frames in the UL, and another set of frames in the DL. FIG. 4 illustrates an expanded view of an exemplary DL subframe 402, showing an OFDM resource grid 404. However, as those skilled in the art will readily appreciate, the PHY transmission structure for any application may vary from the example described here, depending on any quantity of factors. Here, time is in the horizontal direction with units of OFDM symbols; and frequency is in the vertical direction with units of subcarriers or tones.

Resource grid 404 may schematically represent time-frequency resources for a given antenna port. That is, in a MIMO implementation with multiple antenna ports available, a corresponding multiple number of resource grids 404 may be available for communication. Resource grid 404 is divided into multiple resource elements (REs) 406. An RE, which is 1 subcarrier× 1 symbol, is the smallest discrete part of the time-frequency grid and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of resource grid 404. An RB may be the smallest unit of resources that a scheduler can allocate to a UE. Thus, the more RBs scheduled for a UE, and the higher the modulation scheme chosen for the air interface, the higher the data rate for the UE.

In this illustration, RB 408 occupies less than the entire bandwidth of subframe 402, with some subcarriers illustrated above and below RB 408. In a given implementation, subframe 402 may have a bandwidth corresponding to any number of one or more RBs 408. Further, RB 408 is shown occupying less than the entire duration of subframe 402, although this is merely one possible example.

Each 1 ms subframe 402 may include one or multiple adjacent slots. In FIG. 4, one subframe 402 includes four slots 410, as an illustrative example. In some examples, a slot may be defined according to a specified quantity of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of slots 410 illustrates slot 410 including a control region 412 and a data region 414. In general, control region 412 may carry control channels (e.g., PDCCH), and data region 414 may carry data channels (e.g., PDSCH or PUSCH). Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within RB 408 may carry one or more physical channels, including control channels, shared channels, data channels, etc. Other REs 406 within RB 408 may also carry pilots or reference signals. These pilots or reference signals may provide for a receiving device to perform channel estimation of the corresponding channel, which may enable coherent demodulation/detection of the control and/or data channels within RB 408.

In a DL transmission, the transmitting device (e.g., a network node, such as one of scheduling entities 108) may allocate one or more REs 406 (e.g., within a control region 412) to carry one or more DL control channels. These DL control channels include DL control information 114 (DCI) that generally carries information originating from higher layers, such as a physical broadcast channel (PBCH), a physical downlink control channel (PDCCH), etc., to one or more UEs 106. In addition, the network node may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A network node may transmit the synchronization signals PSS and SSS (collectively referred to as SS), and in some examples, the PBCH, in an SS block that includes 4 consecutive OFDM symbols. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a UE) may utilize one or more REs 406 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the network node, such as one of scheduling entities 108) to schedule uplink transmissions. Here, in response to the SR transmitted on the UL control channel 118 (e.g., a PUCCH), the network node may transmit downlink control information (DCI) 114 that may schedule resources for uplink packet transmissions.

In addition to control information, one or more REs 406 (e.g., within the data region 414) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. The RAN may provide this system information utilizing minimum system information (MSI), and other system information (OSI). The RAN may periodically broadcast the MSI over the cell to provide the most basic information a UE requires for initial cell access, and for enabling a UE to acquire any OSI that the RAN may broadcast periodically or send on-demand. In some examples, a network may provide MSI over two different downlink channels. For example, the PBCH may carry a master information block (MIB), and the PDSCH may carry a system information block type 1 (SIB1). Here, the MIB may provide a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the RAN may provide the OSI in these SIBs, e.g., SIB2 and above.

Sidelink communication may be provided over a PC5 interface, which employs PC5 protocols for D2D communication. Other suitable protocols may be utilized for sidelink communication within the scope of this disclosure.

Resource allocation for wireless resources in a sidelink resource pool may employ one of two modes, referred to herein as mode 1 and mode 2. In mode 1, which may be referred to as scheduled resource allocation, the sidelink resource allocation is provided by the RAN. In mode 2, which may be referred to as UE autonomous resource allocation, a UE decides the sidelink transmission resources and timing in the sidelink resource pool.

Sidelink communication may employ several physical channels and physical signals. For example, a physical sidelink control channel (PSCCH) may be used to indicate resources and other transmission parameters that a UE uses for transmission of data on a physical sidelink shared channel (PSSCH). Transmission via the PSCCH may generally include a DM-RS.

Sidelink radio bearers may be categorized into two groups: sidelink data radio bearers for user plane data and sidelink signaling radio bearers for control plane data. FIG. 3B is a schematic illustration of a sidelink user plane protocol stack 360 and a sidelink control plane protocol stack 370 for a sidelink interface between a pair of UEs (labeled UE1 106 and UE2 108) in accordance with some aspects of this disclosure. The sidelink radio protocol architecture is illustrated in FIG. 3B with sidelink user plane protocol stack 360 and sideline control plane protocol stack 370, showing their respective layers or sublayers. Radio bearers between UE 106 and UE 108 may be categorized as data radio bearers (DRB) for carrying user plane data, corresponding to sidelink user plane protocol stack 360; and signaling radio bearers (SRB) for carrying control plane data, corresponding to sidelink control plane protocol stack 370.

Both sidelink user plane protocol stack 360 and sidelink control plane protocol stack 370 include a physical (PHY) layer 362/372, a MAC layer 363/373, a RLC layer 364/374, and a PDPC layer (PDCP) 365/375. PHY layer 362/372 is the lowest layer and implements various physical layer signal processing functions. MAC layer 363/373 provides radio resource selection, packet filtering, priority handling between UL and DL transmissions for a given UE, and sidelink CSI reporting. RLC layer 364/374 provides functions such as sequence numbering, segmentation and reassembly of upper layer data packets, and duplicate packet detection. PDCP layer 365/375 provides functions including header compression for upper layer data packets to reduce radio transmission overhead, security by ciphering the data packets, and integrity protection and verification.

In sidelink user plane protocol stack 360, a service data adaptation protocol (SDAP) layer 366 provides services and functions for maintaining a desired quality of service (QoS), including mapping between a QoS flow and a sidelink data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

In sidelink control plane protocol stack 370, a radio resource control (RRC) layer 376 includes a quantity of functional entities for transferring RRC messages between paired UEs 380, 382, for maintenance and release of an RRC connection between UEs 380, 382, and for detection of a sidelink radio link failure.

An RRC layer corresponding to a Uu interface (i.e., a radio interface between a radio access network and UE) also may include various sidelink-specific services and functions. For example, using the Uu interface, an RRC entity may configure sidelink resource allocation via system information signaling or dedicated signaling. This RRC entity may further be used for measurement configuration and reporting related to the sidelink, and for communication or reporting of UE assistance information relating to sidelink traffic patterns. That is, a UE may report sidelink traffic patterns to the RAN.

Sidelink communications may be supported by a source identifier (ID) and a destination identifier (ID). For example, a source layer-2 ID may identify the source, or sender of sidelink data. A destination layer-2 ID may identify the target, or receiver of sidelink data. Further, a PC5 link ID may be used to uniquely identify a PC5 unicast link in a UE for the lifetime of the PC5 unicast link.

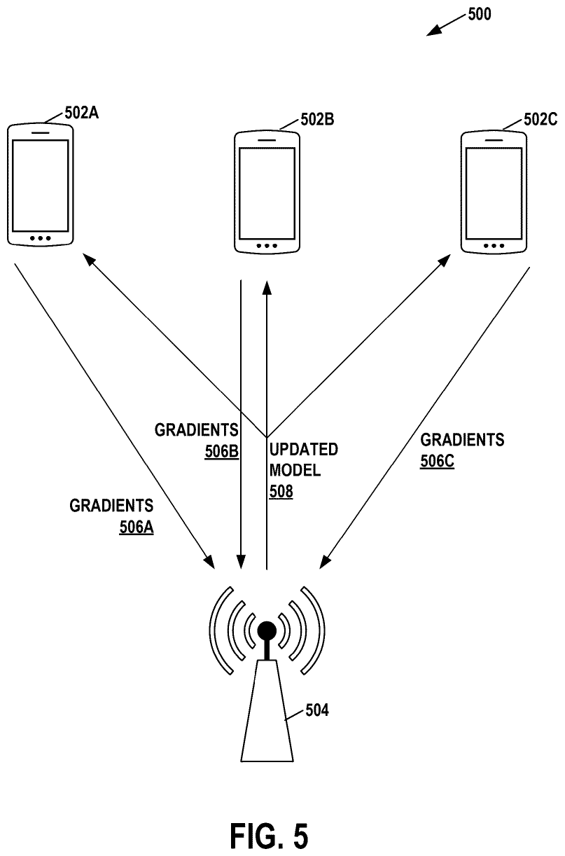

FIG. 5 is a conceptual diagram illustrating an example system 500 that performs federated machine learning, in accordance with one or more techniques of this disclosure. In the example of FIG. 5, system 500 includes a plurality of client devices 502A-502C (collectively, “client devices 502”) and a central device 504. Client devices 502 may be UEs, scheduled entities, base stations (e.g., gNBs) or other types of devices. Central device 504 may be a gNB or another type of device.

Each of client devices 502 may host an individual instance of a ML model. For example, each of client devices 502 may store data describing a structure of the ML model and values of parameters of the ML model. Similarly, central device 504 may store its own instance of the ML model. The ML model may be one of a variety of different types of ML model. For example, the ML model may be an artificial neural network (ANN) model and the parameters may be weights associated with inputs to artificial neurons of the ANN model.

Additionally, each of client devices 502 and central device 504 may store phase values. The phase values may be the same at each of client devices 502 and central device 504. The phase values may be preselected on a pseudo-random basis.

Client devices 502 may individually obtain model input data. Client devices 502 may apply their own instances of an ML model to the model input data to generate model output data. Client devices 502 may use the model output data for various purposes. For example, client devices 502 may obtain data indicating signal strengths of RF signals transmitted by a plurality of fixed-position network nodes, such as wireless base stations. In this example, each of client devices 502 may individually apply their own instances of the ML model to generate model output data that indicates a physical position of the client device. In some such examples, client devices 502 may adjust the power of their RF transmissions based on their physical positions, use beam forming to direct RF signals toward specific base stations, and so on.

As an example, the ML model may take measurements of a reference signal (such as, corresponding to a wide beam) as model input data to predict a channel characteristic associated with a different reference signal (such as, corresponding to a narrow beam within the wide beam, another wide beam, a narrow beam outside the wide beam, etc.). The model input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The model output data may include, for example, compressed channel state information (CSI) feedback or one or more predicted measurements (or characteristics) of one or more reference or pilot signals.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc. In some examples, the model output data indicates a position of the client device.

Additionally, client devices 502 may individually train their instances of the ML model. For instance, in the example where the ML model generates model output data indicating a position of a client device, client devices 502 may receive expected output data (e.g., ground truth information) that indicates actual positions of client devices 502. For example, human users may provide input indicating the actual positions of client devices 502. Each of client devices 502 may apply an error function to the model output data and expected output data. The client device may calculate a gradient of the error function. In some examples, such as examples in which the ML model is an auto-encoder, the expected output data may be the same as the model input data.

Additionally, the client device may generate a plurality of frequency-domain values based on the gradient. The frequency-domain values may indicate phase shifts of frequencies associated with subcarriers. In accordance with one or more techniques of this disclosure, the client device generates modified frequency-domain values based on the phase values and the frequency-domain values. Because the phase values may be selected on a pseudo-random basis (e.g., without correlation among the phase values), application of the phase values to frequency-domain values may reduce the correlation between the frequency-domain values. In other word, the probability of one frequency-domain value being close to another frequency-domain value is reduced. The client device may generate a time-domain digital signal based on modified frequency-domain values. A communication system of the client device may transmit an analog RF signal based on the time-domain digital signal.

The communication systems of the client devices may synchronize transmission of the analog RF signals. Thus, the client device may synchronize transmission of a first analog RF signal with transmission of a second analog RF signal by a second device. The second analog RF signal representing second modified frequency-domain values generated by the second device by applying the phase values to second frequency-domain values. The second frequency-domain values may be generated based on a second gradient of the error function calculated by the second device

A communication system of central device 504 may receive an RF signal that represents an aggregate of the analog RF signals transmitted by client devices 502. Central device 504 may determine modified frequency-domain values on the analog RF signal. Additionally, central device 504 may generate reconstructed frequency-domain values based on the modified frequency-domain values and the phase values. Central device 504 may calculate a gradient of the error function based on the reconstructed frequency-domain values. Furthermore, central device 504 may apply a backpropagation process that updates the values of the model parameters based on the gradient of the error function. The communication system of central device 504 may then transmit model update data to client devices 502. The model update data comprises data the enables client devices 502 to update their values of the model parameters.

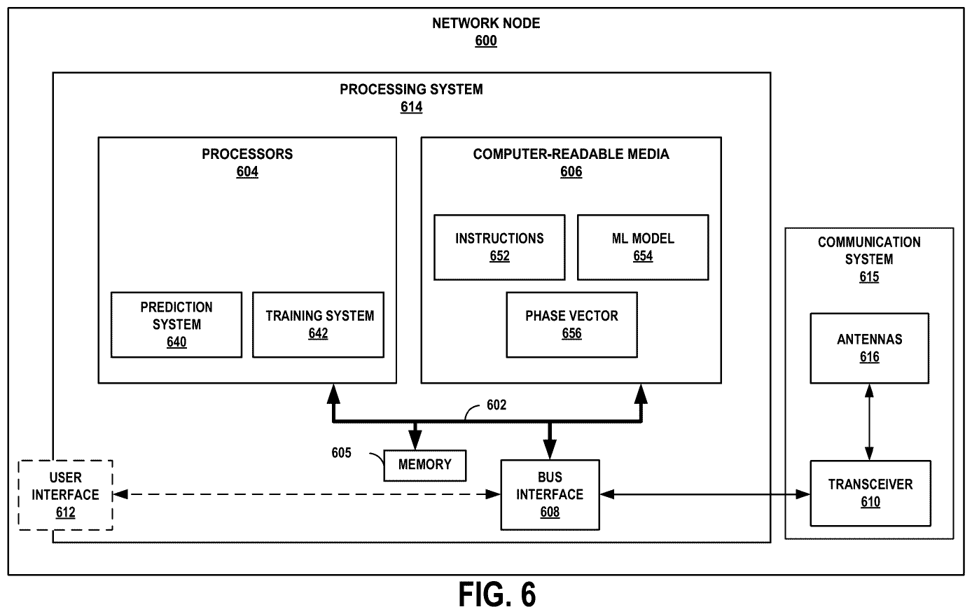

FIG. 6 is a block diagram illustrating an example of a hardware implementation for a network node 600, in accordance with one or more techniques of this disclosure. For example, network node 600 may be a scheduled entity, such as user equipment (UE), or a scheduling entity, such as a base station or gNB. Network node 600 may be a client device (e.g., one of client devices 502) or a central device (e.g., central device 504) of a federated ML system.

Network node 600 includes a bus 602, one or more processors 604, a memory 605, one or more computer-readable media 606, a bus interface 608, a user interface 612, and a communication system 615. Communication system 615 may include a transceiver 610 and one or more antennas 616. A processing system 614 of network node 600 may incorporate bus 602, processors 604, memory 605, one or more computer-readable media 606, and bus interface 608.

Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, network node 600 may be configured to perform any one or more of the functions described herein. For example, processors 604, as utilized in network node 600, may be configured (e.g., in coordination with a memory 605) to implement any one or more of the processes and procedures described in this disclosure.

Processing system 614 may be implemented with a bus architecture, represented generally by bus 602. Bus 602 may include any number of interconnecting buses and bridges depending on the specific application of processing system 614 and the overall design constraints. Bus 602 communicatively couples together various circuits including one or more processors (represented generally by processors 604), memory 605, and one or more computer-readable media (represented generally by computer-readable media 606). Bus 602 may also link various other circuits such as timing sources, peripherals, voltage regulators, and power management circuits, which are well known in the art, and therefore, will not be described any further. A bus interface 608 provides an interface between bus 602 and a transceiver 610. Transceiver 610 provides a communication interface or means for communicating with various other apparatus over a transmission medium. Depending upon the nature of the apparatus, a user interface 612 (e.g., keypad, display, speaker, microphone, joystick) may also be provided. User interface 612 is optional, and some examples, such as a base station, may omit it.

In some aspects of the disclosure, processors 604 may implement a prediction system 640 configured (e.g., in coordination with memory 605) for various functions, including applying a ML model to model input data to generate model output data. Prediction system 640 may also be referred to as an inference system. Processors 604 may also implement a training system 642 configured to train the ML model. In some examples, processors 604 may include special-purpose circuitry for implementing one or more of prediction system 640 and training system 642. In some examples, processors 604 may execute processor-executable instructions that cause processors 604 to implement one or more prediction system 640 and training system 642. Memory 605 and/or computer-readable media 606 may store such processor-executable instructions.

Processors 604 may be responsible for managing bus 602 and general processing, including the execution of software stored on computer-readable media 606. The software, when executed by processors 604, causes processing system 614 to perform the various functions described below for any particular apparatus. Processors 604 may also use computer-readable media 606 and memory 605 for storing data that processors 604 manipulate when executing software.

Processors 604 in processing system 614 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on computer-readable media 606. Computer-readable media 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Computer-readable media 606 may reside in processing system 614, external to processing system 614, or distributed across multiple entities including processing system 614. Computer-readable media 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, computer-readable storage medium 606 may store computer-executable code that includes instructions 652 that configure network node 600 for various functions, including applying an ML model and training the ML model. For example, instructions 652 may be configured to cause network node 600 to implement the techniques of this disclosure as either a client device or a central device. Computer-readable storage medium 606 may also store data representing a ML model 654 and a phase vector 656.

In the above examples, the circuitry included in processors 604 is merely provided as an example, and other means for carrying out the described functions may be included within various aspects of the present disclosure, including but not limited to the instructions stored in the computer-readable storage medium 606, or any other suitable apparatus or means described elsewhere in this disclosure.

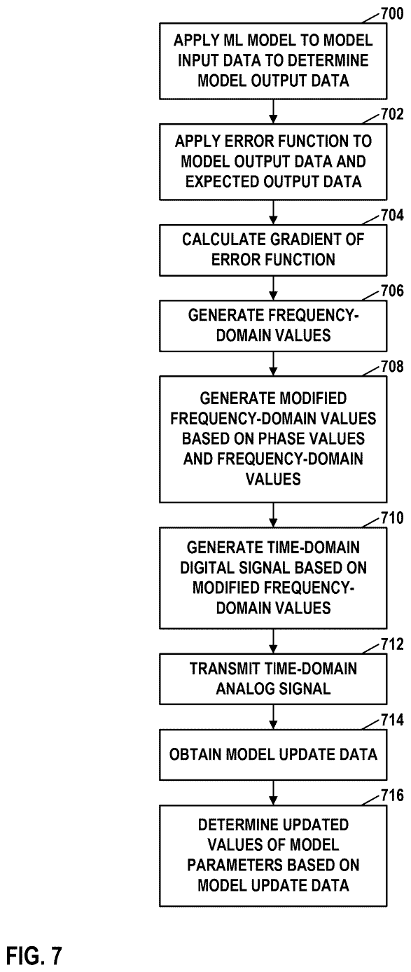

FIG. 7 is a flowchart illustrating an example process performed by client device 502A, in accordance with one or more techniques of this disclosure. The flowchart of FIG. 7 is described with respect to client device 502A but may be applicable with respect to any of client devices 502.

In the example of FIG. 7, client device 502A applies an ML model (e.g., ML model 654) to model input data to determine model output data (700). For example, the ML model may comprise an artificial neural network (ANN) model. In this example, client device 502A may provide the model input data as input to artificial neurons of an input layer of the ANN model and perform a forward pass. In this example, artificial neurons of an output layer of the ANN model may output the model output data.

Additionally, client device 502A may apply an error function to the model output data and expected output data (702). An error value generated by the error function may represent a difference between the model output data and the expected output data. In different examples, client device 502A may apply different error functions. Example error functions may include mean squared error, cross-entropy loss, mean absolute error, Huber loss, Kullback-Leibler Divergence, and so on.

Client device 502A may calculate a gradient of the error function (704). The gradient of the error function may comprise a vector of elements, each of which indicates a partial derivative of the error function with respect to a different model parameter in the plurality of model parameters. Standard mathematical techniques may be used to calculate the gradient. In some examples, client device 502A performs a backpropagation process that updates values of the model parameters based on the gradient. In other examples, client device 502A does not perform the backpropagation process. In some examples, client device 502A quantizes the values in the vector of elements of the gradient.

Furthermore, client device 502A may generate frequency-domain values based on the gradient (706). An OFDM block (i.e., a physical resource block (PRB)) comprises a set of REs that correspond to different subcarriers in a plurality of subcarriers. Each of the subcarriers corresponds to a different frequency. Each of the frequency-domain values is included in a different RE of the OFDM block.

In some examples, client device 502A maps each of the model parameters to a different subcarrier. In such examples, each of the frequency-domain values represents a phase modulation of the frequency of the subcarrier to which the model parameter is mapped. In some examples, client device 502A generates a frequency-domain value by applying the following formula:

$${{g}^{′}}_{k} = {g}_{k} {e}^{2 π j {f}_{k} t}$$

In the formula above, k is an index of a model parameter, gₖ is a scalar value representing a partial derivative of the gradient for the model parameter having index k, e is Euler's number, fₖ is the frequency of the subcarrier mapped to the model parameter having index k, j is \sqrt{−1}, t is a time index, and g′ₖ is a value indicating a frequency-domain value.

In some examples, client device 502A maps pairs of model parameters to individual OFDM subcarriers. In such examples, each of the frequency-domain values represents a phase modulation of the frequency of the subcarrier to which the pair of model parameters is mapped. To do so, client device 502A may apply the following formula:

$${{g}^{′}}_{2 k / 2 k + 1} = ( {g}_{2 k} + {jg}_{2 k + 1} ) {e}^{2 π j {f}_{k} t}$$

In the formula above, 2k is an index of a first model parameter of a pair of model parameters, 2k+1 is an index of a second model parameter of the pair of model parameters, g₂ₖ is a scalar value representing the partial derivative of the gradient for the first model parameter, g2k+1 is a scalar value representing the partial derivative of the gradient for the second model parameter, e is Euler's number, fₓ is the frequency of the subcarrier mapped to the pair of model parameters, j is \sqrt{−1}, and t is a time index. g′_{2k/2k+1} is the frequency-domain value.

Next, client device 502A may generate modified frequency-domain values based on the phase values and the frequency-domain values (708). To apply the phase values to the frequency-domain values, client device 502A may apply the following formula:

$${g}^{″} = {g}^{′} ⊙ φ$$

In the formula above, g″ is a vector of modified frequency-domain values, g′ is a vector of the frequency-domain values, ⊙ represents pair-wise multiplication, and φ is a vector of the phase values. For example, φ may be defined as:

$$φ = {[ {e}^{2 π j {φ}_{k}} ]}_{k}$$

In the formula above, e is Euler's number, j is \sqrt{−1}, k is an index of a model parameter, and φₖ is a preselected value for the k-th model parameter. Thus, client device 502A may perform a pair-wise multiplication of the frequency-domain values with the phase values.

Client device 502A may then generate a digital time-domain signal for the OFDM block based on the modified frequency-domain values (g″) (710). The digital time-domain signal comprises a physical resource block that includes a plurality of resource elements corresponding to different orthogonal frequency division multiplexing (OFDM) subcarriers, each of the resource elements containing a different one of the modified frequency-domain values. Client device 502A may generate the digital time-domain signal for the OFDM block by applying an inverse Fast Fourier Transform (IFFT) to frequency-domain values included in the REs of the OFDM block. In some examples, client device 502A performs constellation mapping on the modified frequency-domain values prior to generating the digital time-domain signal. Thus, in such examples, client device 502A may generate the digital time-domain signal based on the output of the modified frequency-domain values.

Client device 502A may transmit an analog RF signal based on the digital time-domain signal (712). For example, a transceiver of client device 502A may convert the digital time-domain signal to an analog time-domain electrical signal. One or more of antennas of client device 502A may generate the analog RF signal based on the analog time-domain electrical signal. Central device 504 may receive the analog RF signal.

Furthermore, client device 502A may obtain model update data (714). The model update data may be based on the analog RF signal transmitted by client device 502A. Client device 502A may determine updated values of the model parameters based on the model update data (716). For example, client device 502A may receive an analog RF signal from central device 504 or another device representing the model update data. Thus, the updated values of the model parameters may be determined based on gradients independently determined by a plurality of client devices.

In some examples, the model update data includes updated values of the model parameters. In such examples, client device 502A may update the values of the model parameters by replacing existing values of the model parameters with the values of the model parameters included in the model update data. In some examples, the model update data includes indicates a gradient of an error function. In such examples, client device 502A may apply a backpropagation process that uses the gradient of the error function to update the value of the model parameters.

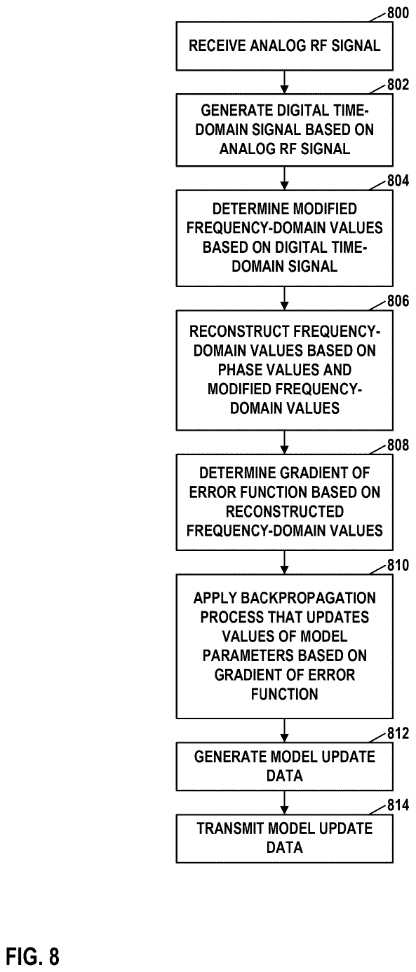

FIG. 8 is a flowchart illustrating an example operation of central device 504, in accordance with one or more techniques of this disclosure. In the example of FIG. 504, central device 504 may receive an analog RF signal (800). The analog RF signal may be an aggregate of analog RF signals transmitted concurrently by client devices 502. In other words, the analog RF signal is a superimposition of a plurality of analog RF signals transmitted by a plurality of client devices. This superimposition may occur naturally as a result of the analog RF signals being transmitted concurrently. For each respective client device of the plurality of client devices, the respective client device stores the phase values and device-specific values of the model parameters of the ML model. The analog RF signal transmitted by the respective client device is based on modified frequency-domain values generated by the respective client device based on the phase values and device-specific frequency-domain values. The device-specific frequency-domain values are generated by the respective client device based on a device-specific gradient of the error function. The device-specific gradient of the error function is determined by the respective client device based on device-specific model output data and device-specific expected output data. The device-specific model output data is determined by the respective client device by the respective client device applying the ML model, using device-specific values of the model parameters to device-specific model input data.

Central device 504 may generate a digital time-domain signal based on the analog RF signal (802). For example, one or more antennas of central device 504 may generate an analog time-domain electrical signal based on the analog RF signal. A transceiver of central device 504 may convert the analog time-domain electrical signal to the digital time-domain signal. The digital time-domain signal comprises a physical resource block that includes a plurality of resource elements corresponding to different orthogonal frequency division multiplexing (OFDM) subcarriers, each of the resource elements containing a different one of the modified frequency-domain values.

Central device 504 may then determine modified frequency-domain values based on the digital time-domain signal (804). For example, central device 504 may apply an FFT to the digital time-domain signal to generate the modified frequency-domain values. The modified frequency-domain values may represent an aggregation of modified frequency-domain values transmitted by client device 502. Each of the modified frequency-domain values corresponds to a different RE of an OFDM block.

Furthermore, central device 504 may reconstruct frequency-domain values based on the phase values and the modified frequency-domain values (806). For example, central device 504 may reconstruct the frequency-domain values by multiplying a vector of modified frequency-domain values by a conjugate of a vector of the phase values. In other words, central device 504 may generate the reconstructed frequency-domain values based on a pair-wise multiplication of a vector of the modified frequency-domain values and a conjugate of the phase values. Thus, in this example, central device 504 may use the following formula to reconstruct the frequency-domain values.

$${g}_{1}^{{}_{′}} + … + {g}_{m}^{{}_{′}} = ( {g}_{1}^{{}_{″}} + … + {g}_{M}^{{}_{″}} ) ⊙ φ ⊙ {φ}^{*}$$

In the formula above, g″₁+ . . . +g″_{M} is a vector in which each element represents an aggregated modified frequency-domain value for a different RE produced by aggregating (e.g., a summation of) the modified frequency-domain values determined for the RE by client devices having indexes 1 through m.

$${g}_{1}^{{}_{′}} + … + {g}_{m}^{{}_{′}}$$

is a vector in which each element represents a reconstructed aggregated frequency-domain value for the RE representing a sum of the frequency-domain values determined for the RE by the client devices having indexes 1 through m. φ is a vector of the phase values. φ* is the conjugate of φ. φ is defined in the same manner as shown above.

Central device 504 may then determine a gradient of the error function based on the reconstructed frequency-domain values (808). In other words, central device 504 may demodulate the reconstructed frequency domain values to determine the gradient of the error function. Central device 504 may then apply a backpropagation process that updates values of model parameters of the ML model based on the gradient of the error function (810).

Furthermore, central device 504 may generate model update data comprising information usable by one or more client devices to update values of the model parameters stored at the one or more client devices to the updated values of the model parameters (812). In some examples, the model update data comprises updated values of the model parameters. In some examples, the model update data comprises data indicating the gradient of the error function. Central device 504 may transmit the model update data to one or more client devices 502 (814).

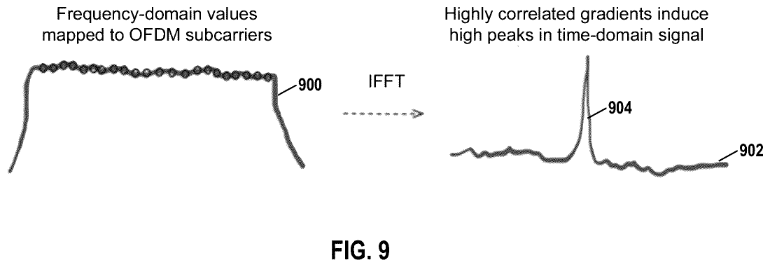

FIG. 9 is a conceptual diagram illustrating an example effect of correlation of frequency-domain values when transformed into a time-domain signal. As previously discussed, a client device may generate frequency-domain values based on the gradient of the error function. Each of the frequency-domain values may correspond to a different OFDM subcarrier. For example, the client device may determine a frequency-domain value by modulating a frequency of an OFDM subcarrier based on one or more partial derivatives of the gradient. A curve 900 shows how the frequency-domain values may be closely correlated.

Furthermore, a client device may apply an IFFT to the frequency-domain values to generate a time-domain signal 902. Because of the high correlation of the frequency-domain values, time-domain signal 902 may include an abrupt peak 904. Such peaks may cause excessive power demands, which may cause problems for some computing devices.

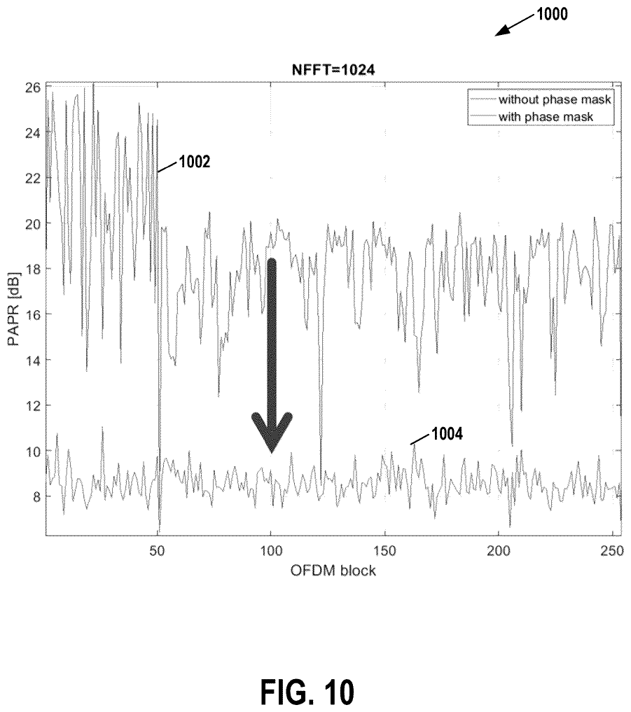

FIG. 10 is a graph 1000 showing an example effect of applying the phase values to the frequency-domain values, in accordance with one or more techniques of this disclosure. A curve 1002 shows peak-to-average power ratios (PAPRs) across OFDM blocks without a phase mask (i.e., without application of the phase values to the frequency-domain values). A curve 1004 shows PAPRs across the OFDM blocks with application of the phase mask. As shown in graph 1000, curve 1004 is more consistent than curve 1002 and does not exhibit the same peaks.

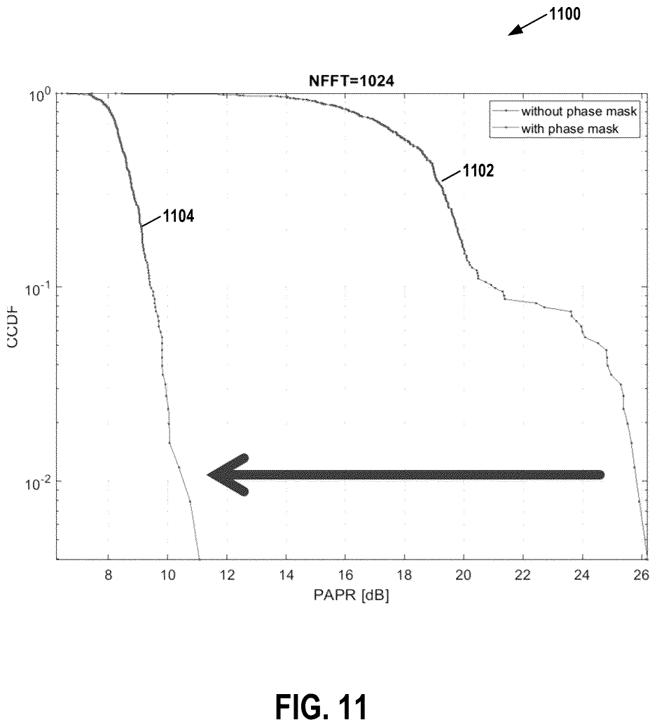

FIG. 11 is a graph 1100 showing an example effect of apply the phase values to the frequency-domain values, in accordance with one or more techniques of this disclosure. A curve 1102 shows complementary cumulative distribution function (CCDF) values across PAPRs without application of the phase mask. A curve 1104 shows CCDF values across PAPRs with application of the phase mask. As shown in graph 1100, curve 1104 shows PAPR reduction.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain model parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights. In some aspects, an ML model may be configured to provide computing capabilities for wireless communications.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values.

Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

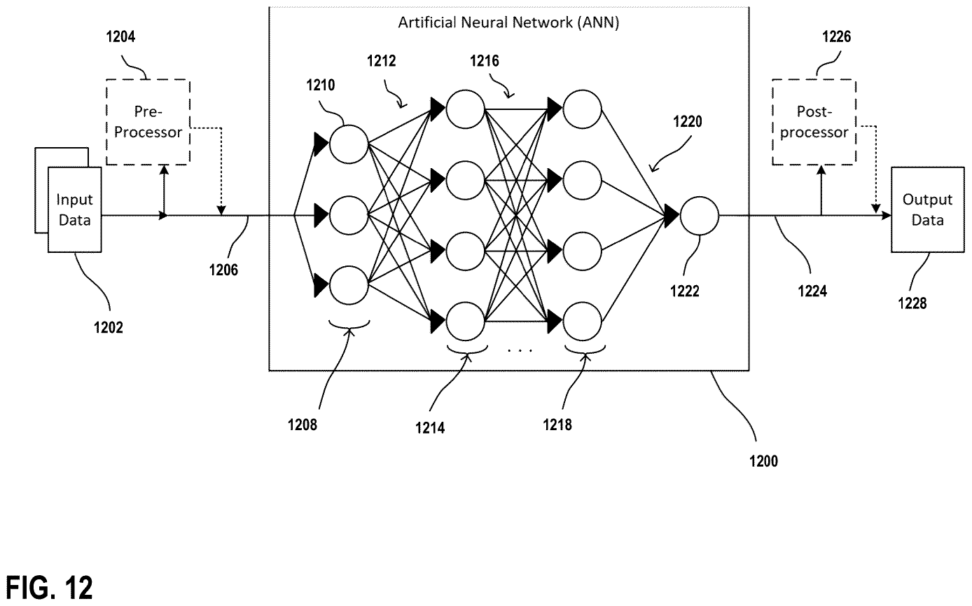

FIG. 12 is an illustrative block diagram of an example machine learning (ML) model represented by an artificial neural network (ANN) 1200 ANN 1200 may receive input data 1202 (i.e., model input data) which may include one or more bits of data, pre-processed data output from pre-processor 1204 (optional), or some combination thereof. Here, data 1202 may include training data, verification data, application-related data, or the like, based, for example, on the stage of deployment of ANN 1200. Pre-processor 1204 may be included within ANN 1200 in some other implementations. Pre-processor 1204 may, for example, process all or a portion of data 1202 which may result in some of data 1202 being changed, replaced, deleted, etc. In some implementations, pre-processor A04 may add additional data to data 1202. In some implementations, the pre-processor A04 may be a ML model, such as an ANN.

ANN 1200 includes at least one first layer 1208 of artificial neurons 1210 to process input data 1206 and provide resulting first layer data via connections or “edges” such as edges 1212 to at least a portion of at least one second layer 1214. Second layer 1214 processes data received via edges 1212 and provides second layer output data via edges 1216 to at least a portion of at least one third layer 1218. Third layer 1218 processes data received via edges 1216 and provides third layer output data via edges 1220 to at least a portion of a final layer 1222 including one or more neurons to provide output data 1224. All or part of output data 1224 may be further processed in some manner by (optional) post-processor 1226. Thus, in certain examples, ANN 1200 may provide output data 1228 that is based on output data 1224, post-processed data output from post-processor 1226, or some combination thereof.

Post-processor 1226 may be included within ANN 1200 in some other implementations. Post-processor 1226 may, for example, process all or a portion of output data 1224 which may result in output data 1228 being different, at least in part, to output data 1224, as result of data being changed, replaced, deleted, etc. In some implementations, post-processor 1226 may be configured to add additional data to output data 1224. In this example, second layer 1214 and third layer 1218 represent intermediate or hidden layers that may be arranged in a hierarchical or other like structure. Although not explicitly shown, there may be one or more further intermediate layers between the second layer 1214 and the third layer 1218. In some implementations, post-processor 1226 may be a ML model, such as an ANN.

The structure and training of artificial neurons 1210 in the various layers may be tailored to specific requirements of an application. Within a given layer such as first layer 1208, second layer 1214, or third layer 1218 of ANN 1200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 1200. The weights and biases of ANN 1200 may be adjusted during a training process or during operation of ANN 1200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 1200, may be conducted using training data. Training data may include one or more datasets which ANN 1200 may use to identify patterns or relationships. Training data may represent various types of information, including written, visual, audio, environmental context, operational properties, etc. During training, the parameters (such as the weights and biases) of artificial neurons 1210 may be changed, such as to minimize or otherwise reduce a loss function or a cost function. A training process may be repeated multiple times to fine-tune ANN 1200 with each iteration.

Various ANN model structures are available for consideration. For example, in a feedforward ANN structure, each artificial neuron 1210 in second layer 1214 receives information from the previous layer (such as, one or more artificial neurons 1210 in first layer 1208) and produces information for the next layer (such as, one or more artificial neurons 1210 in third layer 1218). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 1200 or other ML models may be implemented in various types of processing circuits along with memory and applicable instructions therein. For example, general purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 1200, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

The following is a non-limiting list of clauses in accordance with one or more techniques of this disclosure.

Clause 1. A device for federated machine learning, comprising: a communication system; one or more memories configured to store: values of model parameters of a machine learning (ML) model, and phase values; and one or more processors are configured to: apply the ML model, using the values of the model parameters, to model input data to determine model output data; determine an error function based on the model output data and expected output data; calculate a gradient of the error function; generate a plurality of frequency-domain values based on the gradient; generate modified frequency-domain values based on the phase values and the frequency-domain values; and generate a time-domain digital signal based on the modified frequency-domain values; and wherein the communication system is configured to transmit an analog radio frequency (RF) signal based on the time-domain digital signal.

Clause 2. The device of clause 1, further comprising: obtaining model update data generated based on the analog RF signal; and determining updated values of the model parameters based on the model update data.

Clause 3. The device of clause 2, wherein the updated values of the model parameters are determined based on gradients independently determined by a plurality of client devices.

Clause 4. The device of any of clauses 1-3, wherein: the analog RF signal is a first analog RF signal, the modified frequency-domain values are first modified frequency-domain values, the frequency-domain values are first frequency-domain values, the device is a first device, the gradient is a first gradient, and the one or more processors are configured to synchronize transmission of the first analog RF signal with transmission of a second analog RF signal by a second device, the second analog RF signal representing second modified frequency-domain values generated by the second device by applying the phase values to second frequency-domain values, the second frequency-domain values being generated based on a second gradient of the error function calculated by the second device.

Clause 5. The device of any of clauses 1-4, wherein the one or more processors are configured to perform a backpropagation process that updates the values of the model parameters based on the gradient.

Clause 6. The device of any of clauses 1-4, wherein the device is a User Equipment (UE), the communication system is configured to transmit the analog RF signal to a gNB.

Clause 7. The device of any of clauses 1-6, wherein the model output data indicates a position of the device.

Clause 8. The device of any of clauses 1-7, wherein the one or more processors are configured to, as part of determining the modified frequency-domain values, perform a pair-wise multiplication of the frequency-domain values with the phase values.

Clause 9. The device of any of clauses 1-8, wherein: the one or more processors are configured to, as part of generating the plurality of frequency-domain values, generate the frequency-domain values g′ as

$${g}^{{}_{′}} = {[ {g}_{k} {e}^{2 π j {f}_{k} t} ]}_{k}$$

where gₖ is a partial derivative of the error function for a k-th model parameter of the model parameters, e is Euler's number, j is \sqrt{−1}, fₖ is a frequency of a k-th subcarrier, and t corresponds to a time.

Clause 10. The device of clause 9, wherein the one or more processors are configured to, as part of determining the modified frequency-domain values, perform a pair-wise multiplication of the frequency-domain values with the phase values, wherein a vector of the phase values φ is defined as:

$$φ = {[ {e}^{2 π j {φ}_{k}} ]}_{k}$$

wherein e is Euler's number, j is \sqrt{−1}, k is an index, and or is a preselected value.

Clause 11. The device of any of clauses 1-10, wherein the phase values are preselected pseudo-random values.

Clause 12. The device of any of clauses 1-11, wherein the digital time-domain signal comprises a physical resource block that includes a plurality of resource elements corresponding to different orthogonal frequency division multiplexing (OFDM) subcarriers, each of the resource elements containing a different one of the modified frequency-domain values.

Clause 13. A device for federated machine learning, comprising: a communication system configured to receive an analog RF signal; one or more memories configured to store: values of model parameters of a machine learning (ML) model, and phase values; and one or more processors are configured to: generate a digital time-domain signal based on the analog RF signal; determine modified frequency-domain values based on the digital time-domain signal; reconstruct frequency-domain values based on the phase values and the modified frequency-domain values; determine a gradient of an error function based on the reconstructed frequency-domain values; and apply a backpropagation process that determines updated values of the model parameters based on the gradient of the error function.

Clause 14. The device of clause 13, wherein: the gradient is a first gradient, and the analog RF signal is a superimposition of a plurality of analog RF signals transmitted by a plurality of client devices, wherein, for each respective client device of the plurality of client devices: the respective client device stores the phase values and device-specific values of the model parameters of the ML model, and the analog RF signal transmitted by the respective client device is based on modified frequency-domain values generated by the respective client device based on the phase values and device-specific frequency-domain values, the device-specific frequency-domain values are generated by the respective client device based on a device-specific gradient of the error function, the device-specific gradient of the error function is determined by the respective client device based on device-specific model output data and device-specific expected output data, and the device-specific model output data being determined by the respective client device by the respective client device applying the ML model, using device-specific values of the model parameters to device-specific model input data.

Clause 15. The device of clause 14, wherein the client devices are User Equipment (UE) devices.

Clause 16. The device of any of clauses 13-15, wherein the one or more processors are further configured to: generate model update data comprising information usable by one or more client devices to update values of the model parameters stored at the one or more client devices to the updated values of the model parameters; and transmit the model update data to the one or more client devices.

Clause 17. The device of any of clauses 13-16, wherein the one or more processors are configured to generate the reconstructed frequency-domain values based on a pair-wise multiplication of a vector of the modified frequency-domain values and a conjugate of the phase values.

Clause 18. The device of any of clauses 13-17, wherein the digital time-domain signal comprises a physical resource block that includes a plurality of resource elements corresponding to different orthogonal frequency division multiplexing (OFDM) subcarriers, each of the resource elements containing a different one of the modified frequency-domain values.

Clause 19. The device of any of clauses 13-18, wherein the device is a gNB.

Clause 20. A method for federated machine learning, the method comprising: storing, by a client device of a federated machine learning system, values of model parameters of a machine learning (ML) model; storing, by the client device, phase values; applying, by the client device, the ML model, using the values of the model parameters, to model input data to determine model output data; determining, by the client device, an error function based on the model output data and expected output data; calculating, by the client device, a gradient of the error function; generating, by the client device, a plurality of frequency-domain values based on the gradient; generating, by the client device, modified frequency-domain values based on the phase values and the frequency-domain values; generating, by the client device, a time-domain digital signal based on the modified frequency-domain values; and transmitting, by the client device, an analog radio frequency (RF) signal based on the time-domain digital signal.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in this disclosure may be rearranged and/or combined into a single component, step, feature or function or embodied in several components, steps, or functions. Additional elements, components, steps, and/or functions may also be added without departing from novel features disclosed herein. The apparatus, devices, and/or components illustrated in this disclosure may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A device for federated machine learning, comprising:
a communication system;
one or more memories configured to store:
values of model parameters of a machine learning (ML) model, and phase values; and
one or more processors are configured to:
apply the ML model, using the values of the model parameters, to model input data to determine model output data;
determine an error function based on the model output data and expected output data;
calculate a gradient of the error function;
generate a plurality of frequency-domain values based on the gradient;
generate modified frequency-domain values based on the phase values and the frequency-domain values; and
generate a time-domain digital signal based on the modified frequency-domain values; and
wherein the communication system is configured to transmit an analog radio frequency (RF) signal based on the time-domain digital signal.

2. The device of claim 1, further comprising:
obtaining model update data generated based on the analog RF signal; and
determining updated values of the model parameters based on the model update data.

3. The device of claim 2, wherein the updated values of the model parameters are determined based on gradients independently determined by a plurality of client devices.

4. The device of claim 1, wherein:
the analog RF signal is a first analog RF signal, the modified frequency-domain values are first modified frequency-domain values, the frequency-domain values are first frequency-domain values, the device is a first device, the gradient is a first gradient, and
the one or more processors are configured to synchronize transmission of the first analog RF signal with transmission of a second analog RF signal by a second device, the second analog RF signal representing second modified frequency-domain values generated by the second device by applying the phase values to second frequency-domain values, the second frequency-domain values being generated based on a second gradient of the error function calculated by the second device.

5. The device of claim 1, wherein the one or more processors are configured to perform a backpropagation process that updates the values of the model parameters based on the gradient.

6. The device of claim 1, wherein the device is a User Equipment (UE), the communication system is configured to transmit the analog RF signal to a gNB.

7. The device of claim 1, wherein the model output data indicates a position of the device.

8. The device of claim 1, wherein the one or more processors are configured to, as part of determining the modified frequency-domain values, perform a pair-wise multiplication of the frequency-domain values with the phase values.

9. The device of claim 1, wherein:
the one or more processors are configured to, as part of generating the plurality of frequency-domain values, generate the frequency-domain values g′ as
$${g}^{{}_{′}} = {[ {g}_{k} {e}^{2 π j {f}_{k} t} ]}_{k}$$
where gₖ is a partial derivative of the error function for a k-th model parameter of the model parameters, e is Euler's number, j is \sqrt{−1}, fₖ is a frequency of a k-th subcarrier, and t corresponds to a time.

10. The device of claim 9, wherein the one or more processors are configured to, as part of determining the modified frequency-domain values, perform a pair-wise multiplication of the frequency-domain values with the phase values, wherein a vector of the phase values φ is defined as:
$$φ = {[ {e}^{2 π j {φ}_{k}} ]}_{k}$$
wherein e is Euler's number, j is \sqrt{−1}, k is an index, and φₖ is a preselected value.

11. The device of claim 1, wherein the phase values are preselected pseudo-random values.

12. The device of claim 1, wherein the digital time-domain signal comprises a physical resource block that includes a plurality of resource elements corresponding to different orthogonal frequency division multiplexing (OFDM) subcarriers, each of the resource elements containing a different one of the modified frequency-domain values.

13. A device for federated machine learning, comprising:
a communication system configured to receive an analog RF signal;
one or more memories configured to store:
values of model parameters of a machine learning (ML) model, and phase values; and
one or more processors are configured to:
generate a digital time-domain signal based on the analog RF signal;
determine modified frequency-domain values based on the digital time-domain signal;
reconstruct frequency-domain values based on the phase values and the modified frequency-domain values;
determine a gradient of an error function based on the reconstructed frequency-domain values; and
apply a backpropagation process that determines updated values of the model parameters based on the gradient of the error function.

14. The device of claim 13, wherein:
the gradient is a first gradient, and
the analog RF signal is a superimposition of a plurality of analog RF signals transmitted by a plurality of client devices, wherein, for each respective client device of the plurality of client devices:
the respective client device stores the phase values and device-specific values of the model parameters of the ML model, and
the analog RF signal transmitted by the respective client device is based on modified frequency-domain values generated by the respective client device based on the phase values and device-specific frequency-domain values,
the device-specific frequency-domain values are generated by the respective client device based on a device-specific gradient of the error function,
the device-specific gradient of the error function is determined by the respective client device based on device-specific model output data and device-specific expected output data, and
the device-specific model output data being determined by the respective client device by the respective client device applying the ML model, using device-specific values of the model parameters to device-specific model input data.

15. The device of claim 14, wherein the client devices are User Equipment (UE) devices.

16. The device of claim 13, wherein the one or more processors are further configured to:
generate model update data comprising information usable by one or more client devices to update values of the model parameters stored at the one or more client devices to the updated values of the model parameters; and
transmit the model update data to the one or more client devices.

17. The device of claim 13, wherein the one or more processors are configured to generate the reconstructed frequency-domain values based on a pair-wise multiplication of a vector of the modified frequency-domain values and a conjugate of the phase values.

18. The device of claim 13, wherein the digital time-domain signal comprises a physical resource block that includes a plurality of resource elements corresponding to different orthogonal frequency division multiplexing (OFDM) subcarriers, each of the resource elements containing a different one of the modified frequency-domain values.

19. The device of claim 13, wherein the device is a gNB.

20. A method for federated machine learning, the method comprising:
storing, by a client device of a federated machine learning system, values of model parameters of a machine learning (ML) model;
storing, by the client device, phase values;
applying, by the client device, the ML model, using the values of the model parameters, to model input data to determine model output data;
determining, by the client device, an error function based on the model output data and expected output data;
calculating, by the client device, a gradient of the error function;
generating, by the client device, a plurality of frequency-domain values based on the gradient;
generating, by the client device, modified frequency-domain values based on the phase values and the frequency-domain values;
generating, by the client device, a time-domain digital signal based on the modified frequency-domain values; and
transmitting, by the client device, an analog radio frequency (RF) signal based on the time-domain digital signal.
